(19) United States
(12) Patent Application Publication
(10) Pub. No.: US 2016/0180731 A1
(43) Pub. Date: Jun. 23, 2016

(54) SYSTEM AND METHOD FOR GENERATING A RANK TO LEARNING ARTIFACTS AND PROVIDING RECOMMENDATIONS RESPECTIVE THEREOF

(71) Applicant: FORCLASS LTD., Ramat Gan (IL)

(72) Inventors: Gad ALLON, Wilmette, IL (US); Ofer BELINSKY, Holon (IL); Boaz SHEDLETSKY, Raanana (IL)

(73) Assignee: FORCLASS LTD., Ramat Gan (IL)

(21) Appl. No.: 14/978,244

(22) Filed: Dec. 22, 2015

Related U.S. Application Data
(60) Provisional application No. 62/095,103, filed on Dec. 22, 2014.

(51) Int. Cl. G09B 7/02

(52) U.S. Cl. CPC G09B 7/02

(57) ABSTRACT

A system and method for predicting student engagement respective of a learning artifact including at least one question. The method comprises: receiving a plurality of answers to the at least one question; retrieving an optimal student engagement ratio respective of the learning artifact; analyzing, in real-time, the plurality of answers to determine a current correct answer ratio; and generating, based on the current correct answer ratio and the optimal student engagement ratio, a predictive student engagement rank.

### CROSS-REFERENCE TO RELATED APPLICATIONS

This application claims the benefit of U.S. Provisional Application No. 62/095,103 filed on Dec. 22, 2014, the contents of which are hereby incorporated by reference.

### TECHNICAL FIELD

The present disclosure relates generally to electronic learning (e-learning) systems, and more particularly to systems and methods for enhancing student engagement.

### BACKGROUND

Higher education learning has become an essential step in building a career. In many developed countries, an ever growing proportion of the population has begun entering higher education at some point in their lives. Thus, higher education is crucial to national economies, both as a source of trained personnel for various industries and as an industry in its own right. In many industries, college-educated workers command a significant wage premium and are much less likely to become unemployed than their less-educated counterparts.

Students differ in the teaching methods that work best for them. Despite these differences, different students are taught using the same teaching methods. As a result, some students gain understanding and/or retain knowledge from teaching lessons better than others. Consequently, higher education using traditional teaching methods does not work well for every student. In particular, issues such as large class sizes, classes that do not interest a particular student, and classes that fail to challenge a particular student may prevent that student from becoming fully engaged with the lessons and material, thereby resulting in suboptimal learning.

At best, teachers may attempt to increase the effectiveness of their lessons by utilizing a few different methods to teach students. For example, a teacher may conduct one lesson by lecturing, another by entering a guided discourse with students, and yet another by providing practice exercises. However, such attempts often fail to truly optimize teaching effectiveness because it is difficult to strike the right balance of teaching methods for maximizing student engagement.

Additionally, it is particularly difficult for teachers to effectively gauge student engagement during class. Even if a teacher asks his or her students for feedback about their engagement, students may not provide accurate feedback due to, for example, fear of upsetting the teacher, lack of attention, fear of embarrassment, and so on. As a result, teachers cannot easily adapt their lessons to ensure maximal student engagement. Further, having a teacher determine student engagement is subject to significant potential for human error due to misunderstandings of student responses to lessons.

The suboptimal learning due to this lack of engagement may result in decreased grades, thereby causing students to drop out of the course or, worse, to drop out of the school entirely. For students, the consequences of these actions may include loss of confidence, lack of employment, reduced salaries, reduced flexibility in employment, fewer opportunities for advancement, and other issues for students. Additionally, such dropouts reflect poorly on schools, resulting in reputational harm.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain disclosed embodiments include a method for predicting student engagement respective of a learning artifact including at least one question. The method comprises receiving a plurality of answers to the at least one question; retrieving an optimal student engagement ratio respective of the learning artifact; analyzing, in real-time, the plurality of answers to determine a current correct answer ratio; and generating, based on the current correct answer ratio and the optimal student engagement ratio, a predictive student engagement rank.

Certain disclosed embodiments also include a system for predicting student engagement respective of a learning artifact including at least one question. The system comprises a processing unit; and a memory, the memory containing instructions that, when executed by the processing unit, configure the system to: receive a plurality of answers to the at least one question; retrieve an optimal student engagement ratio respective of the learning artifact; analyze, in real-time, the plurality of answers to determine a current correct answer ratio; and generate, based on the current correct answer ratio and the optimal student engagement ratio, a predictive student engagement rank.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the disclosed embodiments.

FIG. 2 is a flowchart illustrating predicting student engagement with respect to learning artifacts according to an embodiment.

FIGS. 3A and 3B are answer results respective of learning artifacts.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

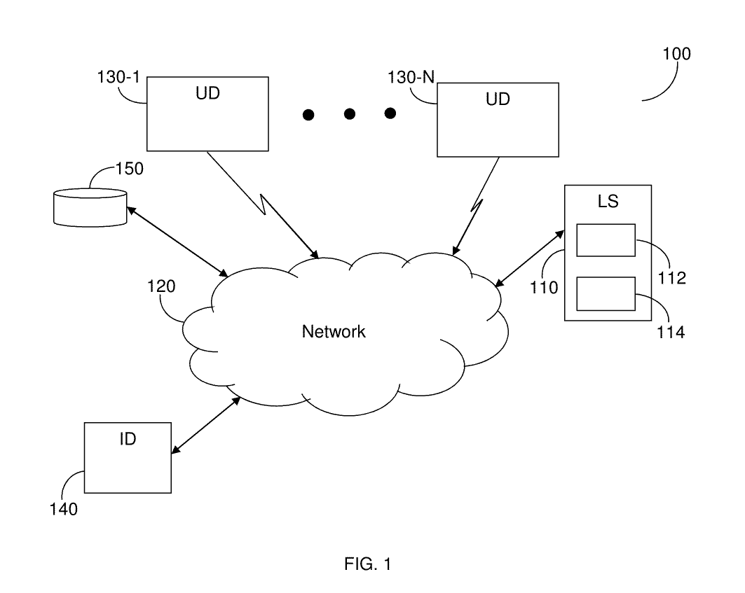

FIG. 1 shows an exemplary and non-limiting network diagram 100 utilized to describe the various disclosed embodiments. The network diagram 100 includes a learning server (LS) 110, a network 120, a plurality of user devices 130-1 through 130-N (hereinafter referred to individually as a student device 130 and collectively as student devices 130, merely for simplicity purposes), an instructor device (ID) 140, and a database 150.

The learning server 110, the student devices 130, the instructor device 140, and the database 150 may be communicatively connected via the network 120. The network 120 may be, but is not limited to, a wireless, cellular, or wired network; a local area network (LAN); a wide area network (WAN); a metro area network (MAN); the Internet; the worldwide web (WWW); similar networks; and any combination thereof.

Each of the student devices 130 and the instructor device 140 may be, but is not limited to, a personal computer, a laptop, a tablet computer, a smartphone, a mobile phone, a wearable computing device, a smart television, and the like. Each student device 130 is typically operated by one or more students or any other person receiving a lesson. The instructor device 140 is typically operated by an instructor or any other person delivering a lesson such as, e.g., a teacher, a professor, and so on.

In an embodiment, the learning server 110 is configured to receive one or more learning artifacts from the instructor device 140. In another embodiment, the learning server 110 may be configured to retrieve any of the learning artifacts from the database 150. Each learning artifact includes learning materials and one or more questions associated with the learning materials to be provided to students during, for example, a lesson. The learning materials may include, but are not limited to, multimedia content items such as, but not limited to, images, videos, audio, combinations thereof, and so on. As a non-limiting example, a learning artifact may include a slideshow presentation as a learning material for use during a lesson on Algebra as well as several multiple choice questions associated with the Algebra lesson.

The learning server 110 is configured to analyze the learning artifacts and to generate metadata respective of the learning artifacts. The metadata may indicate, but is not limited to, a type of the learning artifact (e.g., a type of multimedia content item), a subject associated with the learning artifact (e.g., mathematics, history, language, science, etc.), a course of the learning artifact (e.g., Algebra I, Calculus 101, Chemistry 101, Mechanics, U.S. History II, etc.), the amount of text in the learning artifacts (e.g., a number of words, characters, etc.), one or more question types of the questions associated with the learning materials, past data associated with the learning artifacts (e.g., previous instructor devices and/or student devices associated with the learning artifacts, past student engagement with the learning artifacts, times of previous uses of the learning artifacts such as a particular week of a semester, information associated with related learning artifacts, etc.), and so on. In an embodiment, at least a portion of the metadata may be retrieved from the database 150. The database 150 may further store optimal student engagement ratios as described further herein below.

The learning server 110 is configured to retrieve an optimal student engagement ratio respective of the metadata. The optimal student engagement ratio typically represents high levels of future student engagement with the learning materials as well as student accountability. The optimal student engagement ratio may differ based on the learning artifact and/or based on the number of student devices. In an embodiment, the optimal student engagement ratio may be higher depending upon the level of the students (e.g., preschool, elementary school, junior high school, high school, college, graduate programs, and so on) and/or depending on the size of the class (e.g., a smaller class size may have a higher optimal student engagement ratio). To this end, the metadata may provide information that is relevant to determining which optimal student engagement ratio should be retrieved. As an example, metadata indicating that the learning artifact is presented to a junior high school class may result in an optimal student engagement ratio of 60%, while metadata indicating that the learning artifact is presented to a college class of the same size may result in an optimal student engagement ratio of 90%. As another example, metadata indicating that the learning artifact is presented to a college class of 30 students may result in an optimal student engagement ratio of 80%, while metadata indicating that the learning artifact is presented to a college class of 100 students may result in an optimal student engagement ratio of 70%.

Student engagement and student accountability demonstrate a student's willingness to participate in routine learning activities such as, e.g., attending class, submitting assigned work, and following instructor directions. High levels of student engagement are typically achieved at certain predictable ratios of answers by students respective of a particular learning artifact. Such ratios may be determined based on, but not limited to, an amount of students in a class, a number of students participating in the class (i.e., a number of students who answered each question), feedback from students in the class, combinations thereof, and so on. Such ratios may further be based on the learning artifact. As an example, for a particular learning artifact, a ratio of 80% of students providing correct answers may indicate a low future engagement with the lesson because the students will tend to think that they fully understand the material. As another example, for a particular learning artifact, a ratio of an average score of 5% on a particular set of questions may indicate a low future engagement with the lesson because the students will tend to get frustrated with material they are having difficulty with.

The learning server 110 is configured to send the learning artifacts to the student devices 130. The learning server 110 may send the learning artifacts only to select student devices 130. The student devices 130 may be selected, e.g., via the instructor device 140, based on connections to the network 120 (e.g., all student devices 130 connected to the network 120), automatically based on the metadata, and so on. As an example of automatic selection of student devices 130, when student devices 130-1, 130-2, and 130-3 are selected for a first U.S. history lesson in a series of U.S. history lessons via an instructor device 140, the same student devices 130-1, 130-2, and 130-3 may be automatically selected when the instructor device 140 delivers a lesson on the second U.S. history lesson. The learning server 110 is configured to receive one or more answers from the student devices 130 respective of the learning artifacts.

The learning server 110 analyzes, in real-time, the received answers to determine a current correct answer ratio. Such analysis may include, but is not limited to, determining a total number of answers received for each question, determining a number of correct answers received for each question, determining a number of questions sent to the student devices 130, determining a ratio of correct answers to total answers for a particular question, determining an average score for a set of questions, and so on.

In an embodiment, the learning server 110 is configured to generate a predictive student engagement rank based on the current correct answer ratio and the optimal student engagement ratio. The predictive student engagement rank represents a future engagement of students based on the received answers relative to an ideal engagement and may be, but is not limited to, a percentage (e.g., 50% of maximum engagement), an integer (e.g., a rank of 8 on a scale of 1 to 10, with 1 representing minimal engagement and 10 representing maximal engagement), and so on.

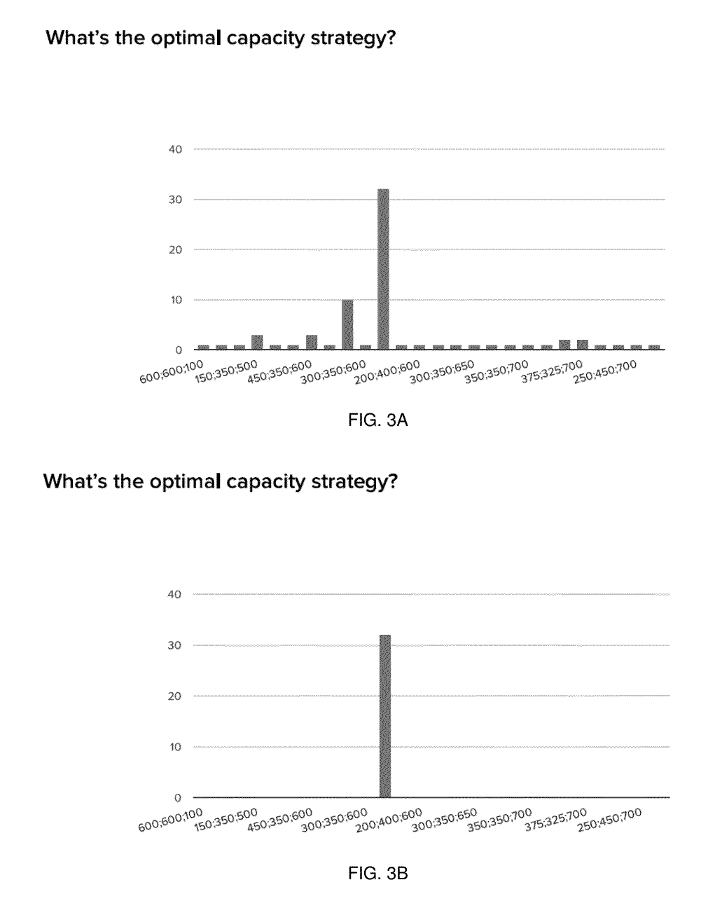

In another embodiment, the learning server 110 may be configured to generate recommendations based on the predictive student engagement rank. In an embodiment, the recommendations may further be based on the learning artifact and/or the metadata. The recommendations may be for increasing student engagement and may include, but are not limited to, increasing a question difficulty, decreasing a question difficulty, increasing a number of questions, decreasing a number of questions, providing additional learning materials, providing fewer learning materials, providing a different type of learning material (e.g., sending a video instead of more textual content), and so on. In a further embodiment, the recommendations may be generated upon generation of a predictive student engagement rank that is below a predefined threshold. The recommendations may be sent to, e.g., the instructor device 140. Generating recommendations based on predictive student engagement ranks is described further herein below with respect to FIGS. 3A and 3B.

The learning server 110 typically includes a processing unit 112 coupled to a memory 114. The processing unit 112 may comprise or be a component of a processor (not shown) or an array of processors coupled to the memory 114. The memory 114 contains instructions that can be executed by the processing unit 112. The instructions, when executed by the processing unit 112, cause the processing unit 112 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be noted that the network diagram 100 is describe herein above with respect to a single instructor device 140 merely for simplicity purposes and without limitation on the disclosed embodiments. Multiple instructor devices may be utilized without departing from the scope of the disclosure.

It should be further noted that the student devices 130 are utilized by students and that the instructor device 140 is utilized by an instructor merely for simplicity purposes and without limitation on the disclosed embodiments. Any other individuals receiving and/or delivering lectures may utilize the student devices 130 and the instructor device 140.

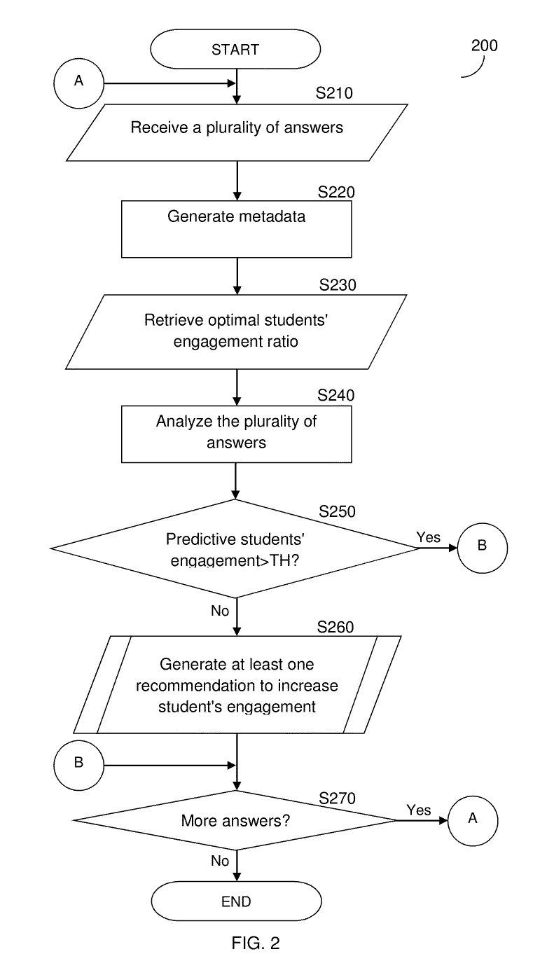

FIG. 2 is an exemplary and non-limiting flowchart 200 illustrating a method for automatically predicting future student engagement with respect to learning artifacts according to an embodiment. In an embodiment, the method may be performed by the learning server 110.

In S210, a plurality of answers respective of a learning artifact is received. The plurality of answers is received in response to one or more questions included in the learning artifact. In an embodiment, the plurality of answers may include sets of answers. Each set of answers is associated with a question included in the learning artifact. In S220, metadata is generated respective of the learning artifact. In an embodiment, S220 may further include retrieving metadata respective of the learning artifact. In S230, an optimal student engagement ratio is retrieved respective of the metadata.

In S240, the plurality of answers is analyzed to generate a predictive student engagement rank. In an embodiment, the analysis includes determining a current correct answer ratio indicating the relative number of correct answers. The current correct answer ratio may be based on, but is not limited to, a number of students who answered a question correctly relative to a total number of students answering the question (e.g., 15/30 students answering a question correctly), an average score on a particular question relative to a total potential score for that question (e.g., ⅘ points scored), an average score on a question set relative to a total potential score for that question set (e.g., 7/10 questions correct on a question set), and so on.

The predictive student engagement rank is generated based on the current ratio and the optimal student engagement ratio. In an embodiment, the predictive student engagement rank may be inversely related to the difference between the current ratio and the optimal student engagement ratio. In a further embodiment, the predictive student engagement rank may be generated further based on the metadata. In yet another embodiment, the predictive student engagement rank may further be based on a distribution of the answers as described further herein below with respect to FIGS. 3A and 3B.

As a non-limiting example, a ratio illustrating an average of 1/10 points scored on a question set may be associated with a low predictive student engagement rank, while a ratio illustrating an average of 7/10 points scored may be associated with a high predictive student engagement rank. As another non-limiting example, a ratio of 45/50 students answering a question correctly may be associated with a low predictive student engagement rank for a Mathematics learning artifact because students may tend to feel that they already know the material and may be associated with a high predictive student engagement rank for a Sociology learning artifact because students having more knowledge about the subject matter allows for more engaging conversations.

In S250, it is checked whether the predictive student engagement rank is above a predetermined threshold and, if so, execution continues with S270; otherwise, execution continues with S260.

In optional S260, one or more recommendations for increasing student engagement may be generated. The recommendations may be sent to, e.g., an instructor device. The recommendations may be generated based on, but not limited to, the predictive student engagement rank, the metadata (e.g., a subject matter of the learning artifact and/or past data related to the learning artifact), a distribution of student answers, and so on. As an example, when no correct answers were received, a recommendation may be to provide additional textual information explaining the material to increase student engagement. In an embodiment, S260 may further include automatically performing one or more actions to increase student engagement based on the recommendations. As an example, when the recommendation is to provide increased textual information, textual information explaining a particular aspect of the question may be automatically retrieved and sent to devices utilized by students.

In S270, it is checked whether additional answers have been received and, if so, execution continues with S210; otherwise, execution terminates. Checking for additional answers allows for analyzing the answers and generating predictive student engagement ranks in real-time, thereby resulting in adjustments to maximize student engagement during an ongoing lesson.

As a non-limiting example, an instructor provides a question to 10 students as part of a learning artifact and an answer is received from each student respective of the question. Metadata indicating that the question includes 100 words is generated. Respective of the metadata, an optimal student engagement ratio of 6/10 of students answering correctly is retrieved. The 10 answers are analyzed to determine that a current ratio of 3/10 students answered the question correctly. Based on the analysis, a predictive student engagement rank of 2 on a scale from 1 to 5 is generated, demonstrating a low future engagement. It is determined that the predictive student engagement rank is below a threshold value of 4, so a recommendation to decrease the difficulty for the next question is generated and sent to an instructor device. The recommendation is generated based on the answers and the metadata, i.e., the relatively low number of correct answers and the length of the question indicate that the question may be too difficult at this time, so an easier question would help increase engagement.

FIGS. 3A and 3B show exemplary and non-limiting answer results 300A and 300B of answer variances for a learning artifact. The answer results 300A indicates a distribution with most of the answers submitted by students being correct (200; 400; 600) and the other answers being somewhat evenly spread among the incorrect answer choices. This indication further suggests a high future engagement. The answer results 300B indicate a distribution with all of the answers submitted by students being correct. This indication suggests active low future engagement. A corresponding recommendation for improving student engagement respective of this set of answer results may be to decrease the amount of textual content being provided to the students in order to challenge the students more, thereby increasing student engagement.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for predicting student engagement respective of a learning artifact including at least one question, comprising:
receiving a plurality of answers to the at least one question;
retrieving an optimal student engagement ratio respective of the learning artifact;
analyzing, in real-time, the plurality of answers to determine a current correct answer ratio; and
generating, based on the current correct answer ratio and the optimal student engagement ratio, a predictive student engagement rank.

2. The method of claim 1, further comprising:
determining whether the predictive student engagement rank is below a predetermined threshold; and
upon determining that the predictive student engagement rank is below the predetermined threshold, generating a recommendation for increasing student engagement.

3. The method of claim 2, wherein the recommendation is generated based on at least one of: the predictive student engagement rank, metadata associated with the learning artifact, and the plurality of answers.

4. The method of claim 2, wherein the recommendation is any of: increasing a question difficulty, decreasing a question difficulty, increasing a number of the at least one question, decreasing a number of the at least one question, providing additional learning materials, providing fewer learning materials, and providing a different type of learning material.

5. The method of claim 1, wherein analyzing the plurality of answers to determine a current correct answer ratio further comprises:
determining a number of answers received; and
determining a number of correct answers received, wherein the current correct answer ratio is equal to the quotient of the number of correct answers received by the number of answers received.

6. The method of claim 1, wherein analyzing the plurality of answers to determine a current correct answer ratio further comprises:
determining an average score for at least one student respective of the at least one question; and
determining a maximum possible score for the at least one question, wherein the current correct answer ratio is equal to the quotient of the average score by the maximum possible score.

7. The method of claim 1, further comprising:
generating metadata respective of the learning artifact, wherein the optimal student engagement ratio is retrieved further respective of the metadata.

8. The method of claim 7, wherein the metadata includes at least one of: a type of the learning artifact, a subject associated with the learning artifact, a course of the learning artifact, an amount of text in the learning artifact, a question type of each of the at least one question, and past data associated with the learning artifact.

9. The method of claim 1, wherein the predictive student engagement rank is inversely proportional to a difference between the current correct answer ratio and the optimal student engagement ratio.

10. A non-transitory computer readable medium having stored thereon instructions for causing one or more processing units to execute the method according to claim 1.

11. A system for predicting student engagement respective of a learning artifact including at least one question, comprising:
a processing unit; and
a memory, the memory containing instructions that, when executed by the processing unit, configure the system to:
receive a plurality of answers to the at least one question;
retrieve an optimal student engagement ratio respective of the learning artifact;
analyze, in real-time, the plurality of answers to determine a current correct answer ratio; and
generate, based on the current correct answer ratio and the optimal student engagement ratio, a predictive student engagement rank.

12. The system of claim 11, wherein the system is further configured to:
determine whether the predictive student engagement rank is below a predetermined threshold; and
upon determining that the predictive student engagement rank is below the predetermined threshold, generate a recommendation for increasing student engagement.

13. The system of claim 12, wherein the recommendation is generated based on at least one of: the predictive student engagement rank, metadata associated with the learning artifact, and the plurality of answers.

14. The system of claim 12, wherein the recommendation is any of: increasing a question difficulty, decreasing a question difficulty, increasing a number of the at least one question, decreasing a number of the at least one question, providing additional learning materials, providing fewer learning materials, and providing a different type of learning material.

15. The system of claim 11, wherein the system is further configured to:
determine a number of answers received; and
determine a number of correct answers received, wherein the current correct answer ratio is equal to the quotient of the number of correct answers received by the number of answers received.

16. The system of claim 11, wherein the system is further configured to:
determine an average score for at least one student respective of the at least one question; and
determine a maximum possible score for the at least one question, wherein the current correct answer ratio is equal to the quotient of the average score by the maximum possible score.

17. The system of claim 11, wherein the system is further configured to:
generate metadata respective of the learning artifact, wherein the optimal student engagement ratio is retrieved further respective of the metadata.

18. The system of claim 17, wherein the metadata includes at least one of: a type of the learning artifact, a subject associated with the learning artifact, a course of the learning artifact, an amount of text in the learning artifact, a question type of each of the at least one question, and past data associated with the learning artifact.

19. The system of claim 11, wherein the predictive student engagement rank is inversely proportional to a difference between the current correct answer ratio and the optimal student engagement ratio.
